(19) United States
(12) Patent Application Publication
(10) Pub. No.: US 2025/0005392 A1
(43) Pub. Date: Jan. 2, 2025

(54) MANAGING DATA INFLUENCED BY A STOCHASTIC ELEMENT FOR USE IN A DATA PIPELINE

(71) Applicant: Dell Products L.P., Round Rock, TX (US)

(72) Inventors: OFIR EZRIELEV, Beer Sheva (IL); HANNA YEHUDA, Acton, MA (US); ANNE-MARIE MCREYNOLDS, San Jose, CA (US)

(21) Appl. No.: 18/343,915

(22) Filed: Jun. 29, 2023

(51) Int. Cl. G06N 5/04

(52) U.S. Cl. CPC G06N 5/04

(57) ABSTRACT

Methods and systems for managing operation of a data pipeline are disclosed. To manage the operation, a system may include one or more data sources, a data manager, and one or more downstream consumers. Changes to a system of representation of information in data requested by the downstream consumers may cause the data pipeline to provide unusable data to the downstream consumers. To remediate the change, a first translation schema may be obtained based on data obtained from the one or more data sources. The data may be influenced by a stochastic element and, therefore, the first translation schema may not successfully remediate the changes. A second translation schema may be obtained using synthetic data obtained from a synthetic data source, the synthetic data source excluding the stochastic element. The second translation schema may successfully remediate the changes and may be implemented in the data pipeline.

### FIELD

Embodiments disclosed herein relate generally to data management. More particularly, embodiments disclosed herein relate to systems and methods to manage data using data pipelines.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIG. 2A shows a block diagram illustrating data flow during remediation of a change in a system of representation of information in data used by the data pipeline in accordance with an embodiment.

FIG. 2B shows a block diagram illustrating data flow during a process of testing a first translation schema for use in the data pipeline in accordance with an embodiment.

FIG. 2C shows a block diagram illustrating data flow during a process of obtaining a second translation schema using synthetic data in accordance with an embodiment.

FIG. 3A shows a flow diagram illustrating a method of managing a data pipeline in accordance with an embodiment.

FIG. 3B shows a flow diagram illustrating a method of identifying that a first translation schema has a first performance score that falls below a performance score threshold in accordance with an embodiment.

FIGS. 4A-4D show block diagrams illustrating a system in accordance with an embodiment over time.

FIG. 5 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

In general, embodiments disclosed herein relate to methods and systems for managing data pipelines. Data usable by a data pipeline may be obtained from any number of data sources. Application programming interfaces (APIs) used by the data pipeline may be configured to consume data with certain characteristics (e.g., data that follows an expected system of representation of information, etc.). For example, a data pipeline may provide temperature measurements obtained from data sources (e.g., entities managing any number of temperature sensors) to downstream consumers of the temperature measurements. The APIs may expect to consume temperature measurements in a previously agreed upon format with a given resolution and units (e.g., with a resolution and unit of the nearest degree Celsius). However, over time, changes to the system of representation of information may occur (e.g., the temperature sensors may be replaced with other temperature sensors, the other temperature sensors having a resolution and unit of the nearest Kelvin, etc.).

Data obtained and fed into the data pipeline that does not meet the expected characteristics may result in unusable data (e.g., data with a unit and/or resolution that is unexpected, etc.) being provided to the downstream consumers. Doing so may cause delays and/or interruptions to the computer-implemented services intended to be provided using the temperature measurements.

To remediate a change in the system of representation of information, the system may perform an anomaly detection process on incoming data to discern whether anomalies (e.g., those caused by the change in the system of representation of information) are present in the incoming data. The anomaly detection process may have characteristics that determine, for example, a sensitivity of the anomaly detection process. The sensitivity of the anomaly detection process (e.g., a magnitude of a threshold for anomalousness) may determine whether anomalies are detected in the incoming data. To selectively detect certain types of anomalies, the sensitivity may be tuned based on needs of the downstream consumers and/or according to other criteria.

For example, a downstream consumer may wish to be alerted of anomalies caused by changes in systems of representation of information in the data. Different types of anomalies may be associated with different degrees of anomalousness (e.g., extents of deviation from what is expected based on the anomaly detection process). An anomaly caused by a change in a system of representation of information (e.g., a change in resolution, units, etc. of data) may be assigned, for example, a degree of anomalousness with a larger deviation from what is expected than other types of anomalies in the data (e.g., caused by a data value deviating from a historic mean value by a certain amount). In addition, an anomaly associated with the change in the system of representation of information may persist over time. Therefore, detection of such an anomaly may trigger a data drift monitoring process to determine whether a data drift has occurred in the incoming data.

To conform to the anomaly detection preferences of the downstream consumer, the sensitivity of the anomaly detection process may be tuned by modifying the threshold for anomalousness. By doing so, anomalies caused by changes in the system of representation of information may be selectively detected (e.g., by increasing the threshold so larger deviations are more likely to be flagged as anomalous and smaller deviations are less likely to be flagged as anomalous).

If an anomaly (e.g., and a subsequent data drift associated with the change in the system of representation of information) is detected in the incoming data, the system may obtain a first translation schema intended to remediate the change in the system of representation of information associated with the anomaly. The first translation schema may be based on historic data previously obtained from the data source (e.g., based on a first system of representation of information) and an updated instance of the first historic data (e.g., based on the second system of representation of information). A testing process may be performed to determine whether the first translation schema successfully translates between systems of representation of information. If the first translation schema is successful, the system may obtain a translation layer (e.g., capable of implementing the first translation schema) into the data pipeline.

However, some data sources (e.g., sensors, etc.) may include a stochastic element that influences data provided by the data sources. Therefore, repeated queries to the data source for a single data value may return a range of responses. Consequently, the first translation schema based on data obtained from the data sources (e.g., the data influenced by the stochastic element) may not reliably translate between systems of representation of information and the first translation schema may be determined unsuccessful.

To remediate the change in the system of representation of information when a stochastic element is present, the system may obtain a second translation schema based on historic data from the data source (e.g., based on the first system of representation of information) and synthetic data (e.g., from a synthetic data source trained to generalize operation of the data source). The synthetic data may be based on the second system of representation of information and may not be influenced by the stochastic element (e.g., due to the synthetic data source not being able to generalize the stochastic element). Elements from the historic data may be reliably mapped to elements of the synthetic data and the second translation schema may be determined to be successful. The system may subsequently perform an action set to implement the second translation layer in the data pipeline.

By doing so, the system may efficiently respond to changes in systems of representation of information in data influenced by a stochastic element and intended for use by the data pipeline. Consequently, future incidents of incomplete, incoherent, and/or otherwise unusable data being provided to the downstream consumers may be reduced (and/or swiftly remediated). Therefore, and downstream consumers associated with the data pipeline may more reliably provide computer-implemented services based on data managed by the data pipeline.

In an embodiment, a method of managing a data pipeline is provided. The method may include: making a first identification that a first translation schema has a first performance score that falls below a performance score threshold, the first translation schema being intended to remediate a change in a system of representation of information conveyed by data obtained from a data source and the data source comprising a stochastic element that influences the data; obtaining, in response to the first identification, a second translation schema based, at least in part, on synthetic data from a synthetic data source, the synthetic data source being intended to generalize operation of the data source and the synthetic data source excluding the stochastic element so that the synthetic data is not influenced by the stochastic element; making a first determination regarding whether the second translation schema has a second performance score that meets the performance score threshold; and in an instance of the first determination in which the second translation schema has the second performance score that meets the performance score threshold: performing an action set to implement the second translation schema in the data pipeline.

The method may also include: prior to making the first identification: making a second determination regarding whether the data comprises anomalous data, the anomalous data indicating the change in the system of representation of information; and in an instance of the second determination in which the data comprises the anomalous data: obtaining the first translation schema.

Obtaining the first translation schema may include: obtaining first historic data, the first historic data being previously provided to one or more downstream consumers and the first historic data being based on a first system of representation of information; issuing a first request for the first historic data from the data source to obtain an updated instance of the first historic data, the updated instance of the first historic data being based on a second system of representation of information; mapping portions of the updated instance of the first historic data to corresponding portions of the first historic data to identify a first relationship between the first system of representation of information and the second system of representation of information; and obtaining the first translation schema based on the first relationship.

Making the first identification may include: obtaining the first performance score, the first performance score indicating a degree to which the first translation schema successfully remediates the change in the system of representation of information; and comparing the first performance score to the performance score threshold.

An influence of the stochastic element on the data may negatively impact the first performance score.

Obtaining the second translation schema may include: obtaining the first historic data; issuing a second request for the first historic data from the synthetic data source to obtain the synthetic data, the synthetic data being based on the second system of representation of information; mapping portions of the synthetic data to corresponding portions of the first historic data to identify a second relationship between the first system of representation of information and the second system of representation of information; and obtaining the second translation schema based on the second relationship.

The synthetic data source may include one selected from a list consisting of: a digital twin of the data source; and an inference model trained to generalize the operation of the data source.

Making the first determination may include: obtaining the second performance score, the second performance score indicating a degree to which the second translation schema successfully remediates the change in the system of representation of information; and comparing the second performance score to the performance score threshold.

Performing the action set may include: obtaining a translation layer for the data pipeline, the translation layer being adapted to initiate implementation of the second translation schema when future instances of data based on the second system of representation of information are identified.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

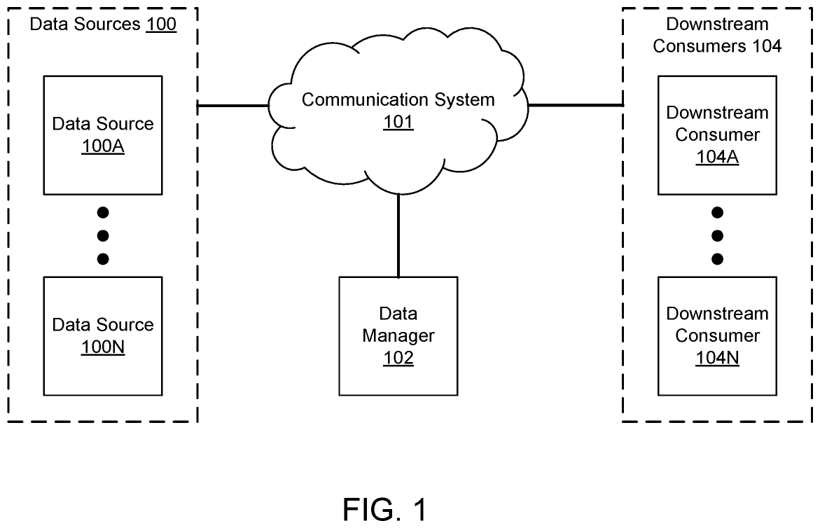

Turning to FIG. 1, a block diagram illustrating a system in accordance with an embodiment is shown. The system shown in FIG. 1 may provide computer-implemented services utilizing data obtained from any number of data sources and managed by a data manager prior to performing the computer-implemented services. The computer-implemented services may include any type and quantity of computer-implemented services. For example, the computer-implemented services may include monitoring services (e.g., of locations), communication services, and/or any other type of computer-implemented services.

To facilitate the computer-implemented services, the system may include data sources 100. Data sources 100 may include any number of data sources. For example, data sources 100 may include one data source (e.g., data source 100A) or multiple data sources (e.g., 100A-100N). Data sources 100 may include any number of internal data sources (e.g., data sources managed and curated by the system of FIG. 1) and/or external data sources (e.g., data sources managed and curated by other entities). Each data source of data sources 100 may include hardware and/or software components configured to obtain data, store data, provide data to other entities, and/or to perform any other task to facilitate performance of the computer-implemented services.

All, or a portion, of data sources 100 may provide (and/or participate in and/or support the) computer-implemented services to various computing devices operably connected to data sources 100. Different data sources may provide similar and/or different computer-implemented services.

For example, data sources 100 may include any number of temperature sensors positioned in an environment to collect temperature measurements according to a data collection schedule. Data sources 100 may be associated with a data pipeline and, therefore, may collect the temperature measurements, may perform processes to sort, organize, format, and/or otherwise prepare the data for future processing in the data pipeline, and/or may provide the data to other data processing systems in the data pipeline (e.g., via one or more APIs).

Data sources 100 may also include any number of synthetic data sources (e.g., digital twins, inference models, etc.). The synthetic data sources may simulate and/or duplicate operation of any number of other data sources associated with data sources 100.

Data sources 100 may provide data to data manager 102. Data manager 102 may include any number of data processing systems including hardware and/or software components configured to facilitate performance of the computer-implemented services. Data manager 102 may include a database (e.g., a data lake, a data warehouse, a data repository, etc.) to store data obtained from data sources 100 (and/or other entities throughout a distributed environment).

Data manager 102 may obtain data (e.g., from data sources 100), process the data (e.g., clean the data, transform the data, extract values from the data, etc.), store the data, and/or may provide the data to other entities (e.g., downstream consumer 104) as part of facilitating the computer-implemented services.

Continuing with the above example, data manager 102 may obtain the temperature measurements from data sources 100 as part of the data pipeline. Data manager 102 may obtain the temperature measurements via a request through an API and/or via other methods. Data manager 102 may curate the temperature data (e.g., identify errors/omissions and correct them, etc.) and may store the curated temperature data temporarily and/or permanently in a data repository and/or other storage architecture. Following curating the temperature data, data manager 102 may provide the temperature measurements to other entities for use in performing the computer-implemented services.

Data managed by data manager 102 (e.g., stored in a data repository managed by data manager 102, obtained directly from internet of things (IoT) devices managed by data manager 102, etc.) may be provided to downstream consumers 104. Downstream consumers 104 may utilize the data from data sources 100 and/or data manager 102 to provide all, or a portion of, the computer-implemented services. For example, downstream consumers 104 may provide computer-implemented services to users of downstream consumers 104 and/or other computing devices operably connected to downstream consumers 104.

Downstream consumers 104 may include any number of downstream consumers (e.g., 104A-104N). For example, downstream consumers 104 may include one downstream consumer (e.g., 104A) or multiple downstream consumers (e.g., 104A-104N) that may individually and/or cooperatively provide the computer-implemented services.

All, or a portion, of downstream consumers 104 may provide (and/or participate in and/or support the) computer-implemented services to various computing devices operably connected to downstream consumers 104. Different downstream consumers may provide similar and/or different computer-implemented services.

Continuing with the above example, downstream consumers 104 may utilize the temperature data from data manager 102 as input data for climate models. Specifically, downstream consumers 104 may utilize the temperature data to simulate future temperature conditions in various environments over time (e.g., to predict weather patterns, climate change, etc.).

Data obtained from data sources 100 may be used by the data pipeline (e.g., may be stored by data manager 102, provided to downstream consumers 104, etc.). Any number of APIs may be integrated into the data pipeline to facilitate communication between components of the data pipeline. Usability of the data (e.g., reliability of data for use in providing computer-implemented services based on the data) provided to downstream consumers 104 may depend on previously determined characteristics of the data (e.g., a system of representation of information, etc.). Data obtained from data sources 100 (and/or requests for the data from downstream consumers 104) that do not include the expected characteristics may result in the data pipeline providing downstream consumers 104 with data that is unusable to perform the computer-implemented services and/or that requires additional resources to modify to a usable format.

In general, embodiments disclosed herein may provide methods, systems, and/or devices for remediating a change in a system of representation of information in data that may negatively impact operations performed by downstream consumers 104. To do so, the system of FIG. 1 may monitor operation of the data pipeline to identify anomalies (e.g., those caused by the change in the system of representation of information) in incoming data from data sources 100 (e.g., via an anomaly detection process, etc.). When anomalies are detected, the system may monitor the anomaly to determine whether the anomaly is persistent over time (e.g., indicating a data drift caused by the change in the system of representation of information). Subsequently, the system may obtain a first translation schema intended to remediate the source of the anomaly (e.g., the change in the system of representation of information).

The first translation schema may be based on first historic data previously obtained from data sources 100 (e.g., based on a first system of representation of information) and an updated instance of the first historic data (e.g., based on the second system of representation of information and obtained by re-querying data sources 100 for the first historic data). A testing process may be performed to determine whether the first translation schema successfully translates between systems of representation of information.

Some of data sources 100 (e.g., sensors, etc.) may include a stochastic element that may influence data provided by data sources 100. Specifically, repeated queries to data sources 100 for the same data may return a range of results. Therefore, the first translation schema based on data obtained from data sources 100 (e.g., the updated instance of the first historic data influenced by the stochastic element) may not reliably translate between systems of representation of information. The testing process may, consequently, determine that the first translation schema is unsuccessful.

To remediate the change in the system of representation of information when a stochastic element is present, the system may obtain a second translation schema based on the first historic data from data sources 100 (e.g., based on the first system of representation of information) and synthetic data (e.g., from a synthetic data source trained to generalize operation of data sources 100). The synthetic data may be based on the second system of representation of information and may not be influenced by the stochastic element (e.g., due to a synthetic data source not being able to generalize the stochastic element). Elements from the historic data may be reliably mapped to elements of the synthetic data and the second translation schema may be determined to be successful.

The system may implement a translation layer to the data pipeline based on the second translation schema. By doing so, future data obtained from data sources 100 may be translated prior to being provided to downstream consumers 104 and, therefore, interruptions to the computer-implemented services based on the data may be reduced.

To provide the above noted functionality, the system of FIG. 1 may: (i) make a first identification that a first translation schema has a first performance score that falls below a performance score threshold (ii) obtain, in response to the first identification, a second translation schema based, at least in part, on synthetic data from a synthetic data source, and/or (iii) determine whether the second translation schema has a second performance score that meets the performance score threshold. If the second translation schema has a second performance score that meets the performance score threshold, the system of FIG. 1 may: perform an action set to implement the second translation schema in the data pipeline.

The first performance score may indicate a degree to which the first translation schema successfully remediates the change in the system of representation of information. The degree may be determined by comparing second historic data (e.g., a portion of historic data not used to obtain the first translation schema) to translated second historic data. The translated second historic data may be obtained by querying the data source that previously provided the second historic data for an updated instance of the second historic data and utilizing the first translation schema to translate the updated instance of the second historic data to a translated instance of the second historic data (e.g., the translated second historic data). A delta between the second historic data and the translated second historic data (as well as any additional parameters including, for example, a penalty for a more complex translation schema) may be utilized to obtain the first performance score.

The synthetic data source may be a digital twin of data sources 100, an inference model trained to generalize operation of data sources 100, and/or any other synthetic data source from which to obtain data representative of data that may be requested from data sources 100 that is not influenced by the stochastic element. To obtain the second translation schema, the first historic data may be obtained and mapped to synthetic data from the synthetic data source, the synthetic data being intended to represent an updated instance of the first historic data based on the second system of representation of information.

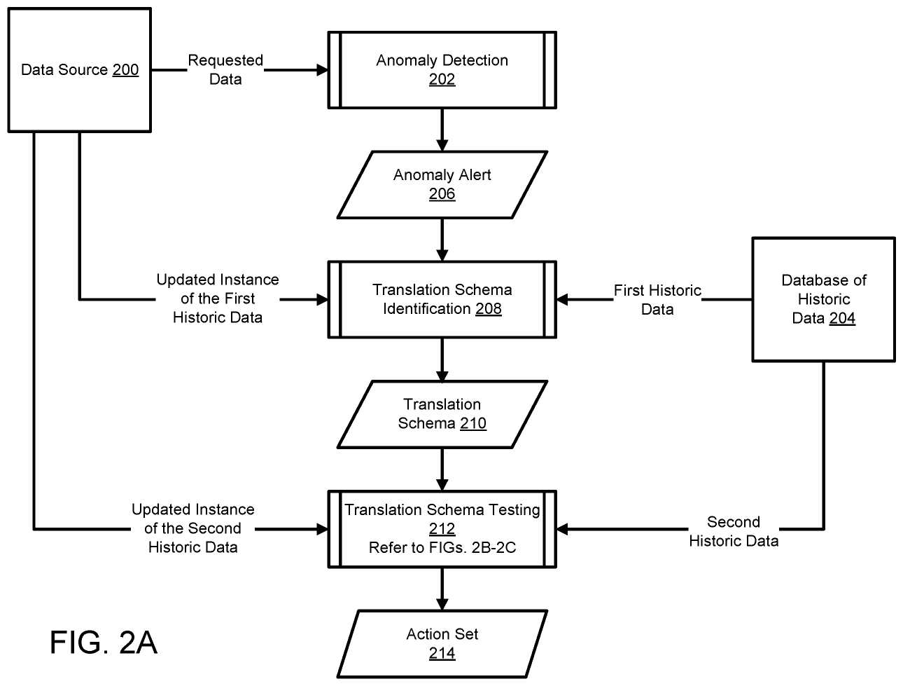

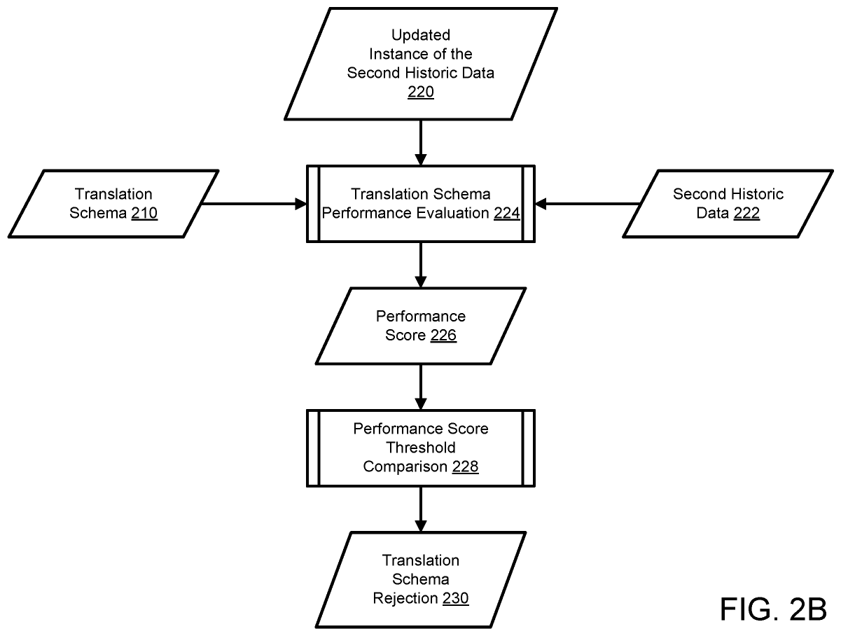

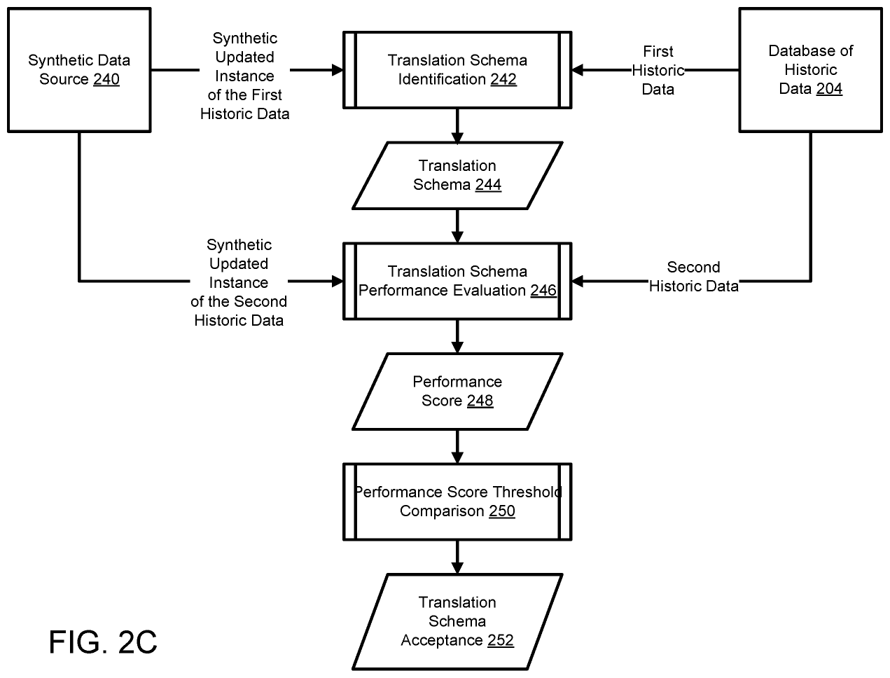

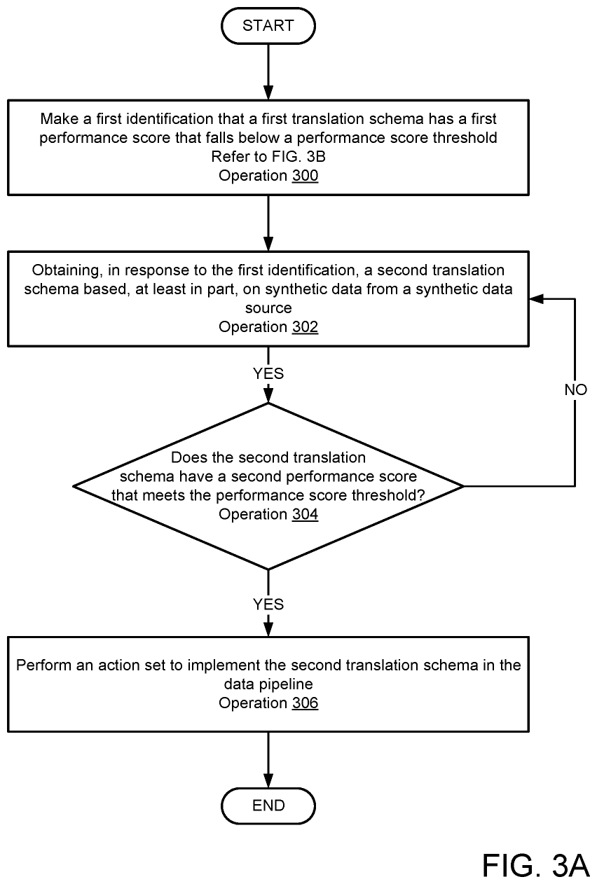

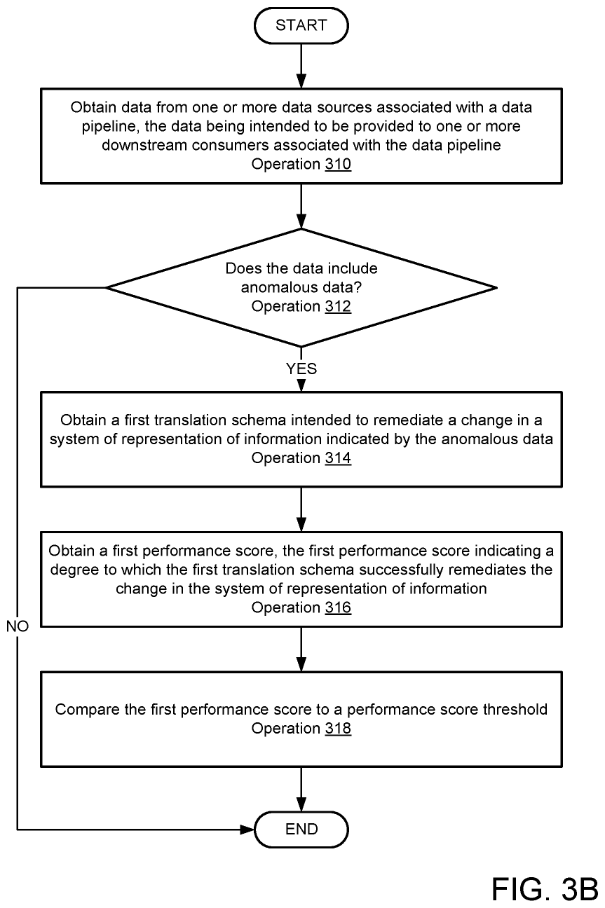

When performing its functionality, data sources 100, data manager 102, and/or downstream consumers 104 may perform all, or a portion, of the methods and/or actions shown in FIGS. 2A-3B.

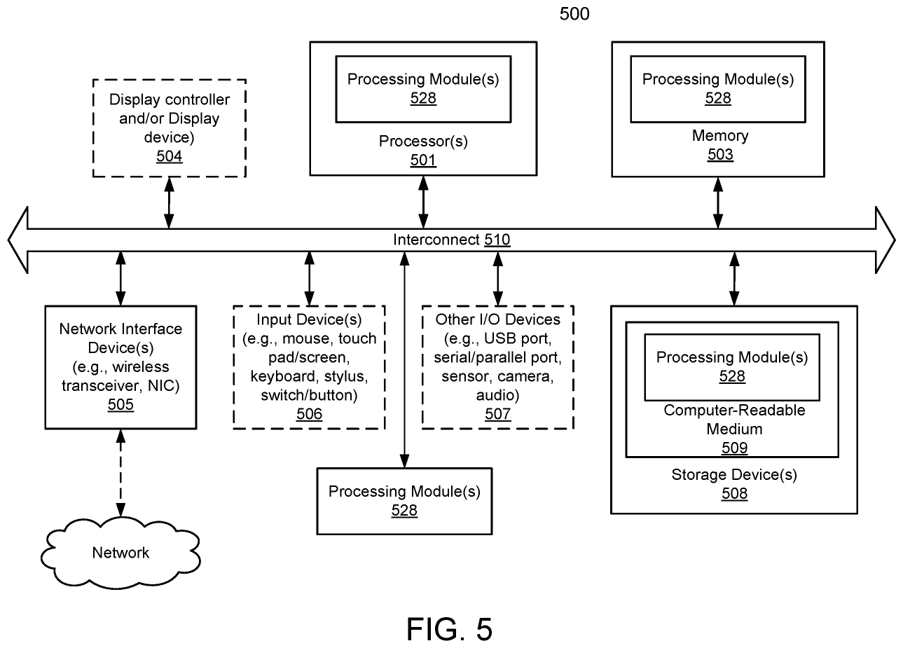

Data sources 100, data manager 102, and/or downstream consumers 104 may be implemented using a computing device such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 5.

In an embodiment, one or more of data sources 100, data manager 102, and/or downstream consumers 104 are implemented using an internet of things (IoT) device, which may include a computing device. The IoT device may operate in accordance with a communication model and/or management model known to data sources 100, data manager 102, downstream consumers 104, other data processing systems, and/or other devices.

Any of the components illustrated in FIG. 1 may be operably connected to each other (and/or components not illustrated) with a communication system 101. In an embodiment, communication system 101 may include one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

To further clarify embodiments disclosed herein, diagrams illustrating data flows and/or processes performed in a system in accordance with an embodiment are shown in FIGS. 2A-2C.

FIG. 2A shows a block diagram illustrating data flow during remediation of a change in a system of representation of information in data used by the data pipeline in accordance with an embodiment. The processes shown in FIG. 2A may be performed by any entity shown in the system of FIG. 1 (e.g., a data source similar to data source 100A, a data manager similar to data manager 102, a downstream consumer similar to downstream consumer 104A, etc.) and/or another entity without departing from embodiments disclosed herein.

Consider a scenario in which a downstream consumer (e.g., similar to any of downstream consumers 104 shown in FIG. 1) provides computer-implemented services using data managed by a data pipeline. To do so, the downstream consumer may request data from other portions of the data pipeline.

In response to the request, requested data may be obtained from data source 200 (e.g., similar to any of data sources 100 shown in FIG. 1). The requested data may include any type and quantity of data encapsulated in a data structure and intended to be provided to the downstream consumer. The requested data may have any number of characteristics (e.g., types of parameters, a number of parameters, an ordering of the parameters) and may be based on a system of representation of information (e.g., each entry of the requested data may have a particular resolution, unit, etc.). The requested data may, for example, include a series of temperature measurements with a resolution of the nearest tenth of a degree Celsius.

The requested data (and/or any other data obtained from the data sources) may undergo anomaly detection 202 process prior to being provided to the downstream consumer via one or more APIs. Anomaly detection 202 process may include, for example, any statistical analysis of the requested data (e.g., cluster analysis, Z-score analysis, etc.) to determine a degree of anomalous of the requested data. Anomaly detection 202 process may also be performed using an inference model (e.g., a neural network) trained to identify anomalies in the requested data based on historic data trends.

Anomaly detection 202 process may have a tunable sensitivity based on a preference indicated by the downstream consumer. The sensitivity may indicate a range of data that is considered non-anomalous by the downstream consumer. The range of data may be defined by any metric (e.g., a static and/or dynamic threshold for anomalousness, etc.) and may be modified over time as needed to account for changes in data provided by data source 200 and/or changes to the needs of the downstream consumer.

The data range may be selected, for example, based on a degree of anomalousness likely to indicate a change in a system of representation of information in data obtained from data source 200. Therefore, the requested data may be based on a first system of representation of information when the requested data is within the range of the data that is considered non-anomalous by the one or more downstream consumers and the requested data may be based on a second system of representation of information when the requested data is outside the range of the data that is considered non-anomalous by the one or more downstream consumers.

The change in the system of representation of information may be based on a first identification that the first system of representation of information is used and a second identification that the second system of representation of information (e.g., any system of representation of information that is different from the first system of representation of information) has replaced the first system of representation of information in the requested data (and/or other data). Therefore, the requested data may include anomalous data when at least a portion of the requested data is outside the range of the data that is considered non-anomalous by the one or more downstream consumers.

The system of representation of information may include, for example, a unit change (e.g., temperature measurements to a tenth of a degree Celsius compared to temperature measurements in Kelvin), a resolution change (e.g., grams to milligrams), and/or other characteristics. Data based on the second system of representation of information may have a first resolution of the data (and/or a first unit) and data based on the first system of representation of information may have a second resolution of the data (and/or a second unit).

For example, first temperature measurements based on the first system of representation of information of representation may deviate from past and/or predicted future data by a certain amount and may be assigned a first degree of anomalousness. However, second temperature measurements based on the second system of representation of information (e.g., with a different resolution and/or unit) may be assigned a second degree of anomalousness, the second degree of anomalousness indicating a larger deviation from what is expected than the first degree of anomalousness.

The range of data (and, therefore, the threshold for anomalousness) may be modified so that the second temperature measurements (e.g., with the second degree of anomalousness) are flagged as anomalous and the first temperature measurements (e.g., with the first degree of anomalousness) are not flagged as anomalous. The sensitivity may be modified (e.g., tuned) so that anomaly detection 202 process selectively identifies anomalies that are likely to be caused by changes in the system of representation of information.

In addition, detection of an anomaly with the second degree of anomalousness may trigger a data drift monitoring process (not shown) to determine whether the anomaly persists in the incoming data. If the anomaly persists, the anomaly is more likely to be caused by the change in the system of representation of information than if the anomaly is only detected once (or a few times) over time.

Anomaly detection 202 process may generate anomaly alert 206 when an anomaly is detected in the requested data. Anomaly alert 206 may include a notification of the detected anomaly, information related to the detected anomaly, and/or other information encapsulated in a data structure. The information related to the detected anomaly may include: (i) the anomalous portion of the requested data, (ii) one or more identifiers associated with the anomalous portion of the requested data (e.g., timestamps, identification numbers, access credentials for accessing the anomalous data, etc.), (iii) information regarding a type of anomaly suspected to exist in the requested data (e.g., the change in the system of representation of information), and/or (iv) other information.

Anomaly alert 206 may trigger performance of translation schema identification 208 process. Translation schema identification 208 process may utilize anomaly alert 206, first historic data from database of historic data 204, updated instance of the first historic data from data source 200, and/or other data to obtain translation schema 210. To do so, translation schema identification 208 process may include obtaining first historic data from database of historic data 204. The first historic data may have been previously provided to the downstream consumer and the first historic data may have been based on the first system of representation of information. Therefore, the first historic data may not have been treated as including anomalous data.

Following obtaining the first historic data, a first request may be issued to data source 200 (e.g., the data source from which the first historic data was previously obtained) for the first historic data (not shown). The updated instance of the first historic data may be obtained in response to the first request. The updated instance of the first historic data may be based on the second system of representation of information. The requested data may also utilize the second system of representation of information and, therefore, the updated instance of the first historic data may include anomalies similar to those identified in the requested data. However, data source 200 may include a stochastic element that influences data provided by data source 200. Therefore, the updated instance of the first historic data may not include a consistently reliable representation of the second system of representation in data obtained from data source 200 by the data pipeline over time.

Translation schema identification 208 process may also include mapping portions of the updated instance of the first historic data to corresponding portions of the first historic data to identify a relationship between the first system of representation of information and the second system of representation of information. Translation schema 210 may be obtained based on the relationship. Translation schema 210 may include instructions for performing a process (e.g., an algorithm) for ingesting data based on the second system of representation of information and translating the data to an instance of the data that is based on the first system of representation of information. Therefore, translation schema 210 may be intended to remediate the change in the system of representation of information conveyed by the data obtained from data source 200.

To determine whether translation schema 210 successfully translates the second system of representation of information to the first system of representation of information, translation schema testing 212 process may be performed. Translation schema testing 212 process may utilize translation schema 210, historic data from database of historic data 204, and/or other data to test translation schema 210.

Translation schema testing 212 process may include obtaining second historic data from database of historic data 204, issuing a second request for the second historic data from data source 200 (e.g., the data source from which the second historic data was previously obtained) (not shown), and obtaining an updated instance of the second historic data in response to the request. The second historic data may be different from the first historic data and the second historic data may be based on the first system of representation of information. In addition, the updated instance of the second historic data may be based on the second system of representation of information.

The influence of the stochastic element from data source 200 may cause the mapping between the first historic data and the updated instance of the first historic data to be unreliable. Therefore, translation schema 210 may not translate the updated instance of the second historic data to an extent considered acceptable (e.g., by a downstream consumer, etc.).

In FIG. 2A, translation schema 210 may be considered unsuccessful (due to the above mentioned stochastic element and unreliable mapping of data) and a second translation schema may be obtained in response to the unsuccessful result. Refer to FIGS. 2B-2C for additional details regarding testing the first translation schema and obtaining the second translation schema.

The second translation schema may also be tested and may be considered successful. In response to the successful testing of the second translation schema, action set 214 may be obtained. Action set 214 may include instructions for remediating the change in the system of representation of information identified in the requested data using the second translation schema. Action set 214 may include, for example, instructions for generating and implementing a translation layer (not shown) in the data pipeline. The translation layer may be adapted to initiate implementation of the second translation schema when future instances of data based on the second system of representation of information are identified.

Action set 214 may also include an indication that the translation layer is keyed to data source 200, and, therefore, the translation layer may be activated only when future data is obtained from data source 200.

In addition, action set 214 may include generating and providing a notification of the actions performed (e.g., implementing the translation layer) to any entity (e.g., the downstream consumer, administrators responsible for managing the data pipeline, etc.).

Turning to FIG. 2B, a block diagram is shown illustrating data flow during a process of testing a first translation schema for use in the data pipeline in accordance with an embodiment. The processes shown in FIG. 2B may be performed by any entity shown in the system of FIG. 1 (e.g., a data source similar to data source 100A, a data manager similar to data manager 102, a downstream consumer similar to downstream consumer 104A, etc.) and/or another entity without departing from embodiments disclosed herein. The data flow shown in FIG. 2B may be an expansion of at least a part of translation schema testing 212 process shown in FIG. 2A.

Updated instance of the second historic data 220 may be similar to the updated instance of the second historic data described in FIG. 2A and used for translation schema testing 212 process. Second historic data 222 may be similar to the second historic data described in FIG. 2A and used for translation schema testing 212 process. Translation schema testing 212 process (not shown in FIG. 2B) may include using updated instance of second historic data 220, second historic data 222, and translation schema 210 to perform translation schema performance evaluation 224 process.

Translation schema performance evaluation 224 process may include utilizing translation schema 210 to translate updated instance of the second historic data 220 (based on the second system of representation of information) to a translated instance of the second historic data (not shown and based on the first system of representation of information). The translated instance of the second historic data may be intended to match second historic data 222 within a threshold if translation schema 210 is successful.

Translation schema performance evaluation 224 process may include obtaining performance score 226, performance score 226 indicating a degree to which the translated instance of the second historic data remediates the change in the system of representation of information (e.g., matches second historic data 222). The influence of the stochastic element on the data obtained from data source 200 (e.g., updated instance of the second historic data 220) may negatively impact performance score 226.

Performance score 226 may be based on additional parameters including, for example, a degree of complexity of translation schema 210. Translation schema performance evaluation 224 may penalize performance scores for translation schemas as the degree of complexity of the translation schemas increase.

Performance score 226 may be used for performance score threshold comparison 228 process. Performance score threshold comparison 228 process may include comparing performance score 226 to a performance score threshold (not shown). The performance score threshold may be provided by a downstream consumer and/or any other entity to indicate an acceptable degree to which translation schema 210 should be able to successfully remediate the change in the system of representation of information (and/or potentially taking into account other factors such as the complexity of translation schema 210) in order to be implemented in the data pipeline.

In FIG. 2B, performance score 226 may not meet the performance score threshold (e.g., due, at least in part, to the influence of the stochastic element described in FIG. 2A from data source 200). Therefore, performance score threshold comparison 228 process may generate translation schema rejection 230. Translation schema rejection 230 may include a notification that translation schema 210 may not be implemented in the data pipeline and may trigger the operations shown in FIG. 2C.

Turning to FIG. 2C, a block diagram is shown illustrating data flow during a process of obtaining a second translation schema using synthetic data in accordance with an embodiment. The processes shown in FIG. 2C may be performed by any entity shown in the system of FIG. 1 (e.g., a data source similar to data source 100A, a data manager similar to data manager 102, a downstream consumer similar to downstream consumer 104A, etc.) and/or another entity without departing from embodiments disclosed herein. The data flow shown in FIG. 2C may be an expansion of at least a portion of translation schema testing 212 process shown in FIG. 2A and partially expanded upon in FIG. 2B.

Following generation of translation schema rejection 230 in FIG. 2B, the system shown in FIG. 1 may initiate generation of a new translation schema (e.g., translation schema 244) via translation schema identification 242 process. Translation schema identification 242 process may be similar to translation schema identification 208 process shown in FIG. 2A. However, instead of utilizing the updated instance of the first historic data from data source 200 (in translation schema identification 208 process), translation schema identification 242 process may utilize synthetic updated instance of the first historic data from synthetic data source 240 and the first historic data from database of historic data 204 to obtain translation schema 244.

Synthetic data source 240 may be a digital twin of data source 200, an inference model, and/or any other synthetic data source intended to generalize the operation of data source 200. Synthetic data source 240 may provide data based on the same system of representation of information as data source 200. However, synthetic data source 240 may exclude the stochastic element and synthetic data provided by synthetic data source 240 may not be influenced by the stochastic element. Consequently, repeated queries to synthetic data source 240 for the same data (e.g., synthetic data corresponding to a time interval, a timestamp, etc.) may return identical synthetic data.

Translation schema identification 242 process may include mapping portions of the synthetic updated instance of the first historic data to corresponding portions of the first historic data to identify a relationship between the first system of representation of information and the second system of representation of information. Translation schema 244 may be obtained based on the relationship. Translation schema 244 may include instructions for performing a process (e.g., an algorithm) for ingesting data based on the second system of representation of information and translating the data to an instance of the data that is based on the first system of representation of information.

The synthetic updated instance of the first historic data may include data values intended to match the data values of the first historic data (e.g., due to matching queries for data from a specified time interval, etc.) and based on the second system of representation of information. Therefore, the synthetic updated instance of the first historic data may be based on the second system of representation of information but may not be influenced by the stochastic element that influenced the updated instance of the second historic data obtained from data source 200 in FIG. 2B.

To determine whether translation schema 244 successfully translates the second system of representation of information to the first system of representation of information, translation schema performance evaluation 246 process may be performed. Translation schema performance evaluation 246 process may utilize translation schema 244, the second historic data from database of historic data 204, and/or synthetic updated instance of the second historic data from synthetic data source 240 to test translation schema 244.

The synthetic updated instance of the second historic data may be similar to updated instance of the second historic data 220 described in FIG. 2B but may be obtained from synthetic data source 240 instead of data source 200 and, therefore, may not be influenced by the stochastic element. The second historic data may be similar to second historic data 222 described in FIG. 2B and may be used for translation schema performance evaluation 246 process.

Translation schema performance evaluation 246 process may include utilizing translation schema 244 to translate the synthetic updated instance of the second historic data (based on the second system of representation of information) to a translated synthetic instance of the second historic data (not shown and based on the first system of representation of information). The translated synthetic instance of the second historic data may be intended to match the second historic data within a threshold if translation schema 244 is successful.

Translation schema performance evaluation 246 process may include obtaining performance score 248, performance score 248 indicating a degree to which translation schema 244 successfully remediates the change in the system of representation of information (e.g., how well the translated synthetic instance of the second historic data matches the second historic data). Translation schema performance evaluation 246 process may also take into account other factors related to translation schema 244 including, for example, the complexity of translation schema 244. As previously described in FIG. 2B, performance scores for translation schemas may be penalized as the complexity of translation schemas increases and, therefore, translation schemas that are less complex may be assigned performance scores that indicate a more successful remediation of the change in the system of representation of information.

Performance score 248 may be used for performance score threshold comparison 250 process. Performance score threshold comparison 250 process may include comparing performance score 248 to a performance score threshold (not shown). The performance score threshold may be provided by a downstream consumer and/or any other entity to indicate an acceptable degree to which translation schema 244 should be able to successfully remediate the change in the system of representation of information in order to be implemented in the data pipeline.

In FIG. 2C, performance score 248 may meet the performance score threshold (e.g., due, at least in part, to the absence of the influence of the stochastic element described in FIG. 2A from data source 200). Therefore, performance score threshold comparison 250 process may generate translation schema acceptance 252. Translation schema acceptance 252 may include a notification that translation schema 244 may be implemented in the data pipeline and may trigger generation of action set 214 shown in FIG. 2A.

By doing so, future instances of changes in the system of representation of information identified in data from data source 200 (and/or other data sources) may be reduced and the reliability of computer-implemented services based on data from data source 200 (and/or other data sources) may be increased.

In an embodiment, the one or more entities performing the operations shown in FIGS. 2A-2C are implemented using a processor adapted to execute computing code stored on a persistent storage that when executed by the processor performs the functionality of the system of FIG. 1 discussed throughout this application. The processor may be a hardware processor including circuitry such as, for example, a central processing unit, a processing core, or a microcontroller. The processor may be other types of hardware devices for processing information without departing from embodiments disclosed herein.

As discussed above, the components of FIG. 1 may perform various methods to manage operation of a data pipeline. FIGS. 3A-3B illustrate methods that may be performed by the components of FIG. 1. In the diagram discussed below and shown in FIGS. 3A-3B, any of the operations may be repeated, performed in different orders, and/or performed in parallel with or in a partially overlapping in time manner with other operations.

Turning to FIG. 3A, a flow diagram illustrating a method of managing a data pipeline in accordance with an embodiment is shown. The method may be performed, for example, by a data source, data manager, downstream consumer, and/or any other entity.

At operation 300, a first identification is made that a first translation schema has a first performance score that falls below a performance score threshold. Making the first identification may include: (i) obtaining data from one or more data sources associated with a data pipeline, and/or (ii) determining whether the data includes anomalous data. In an instance where the data does include the anomalous data, making the first identification may include: (i) obtaining the first translation schema intended to remediate a change in a system of representation of information indicated by the anomalous data, (ii) obtaining a first performance score, and/or (iii) comparing the first performance score to the performance score threshold. Refer to FIG. 3B for additional details regarding making the first identification.

At operation 302, a second translation schema is obtained in response to the first identification, the second translation schema being based, at least in part, on synthetic data from a synthetic data source.

Obtaining the second translation schema may include: (i) obtaining the first historic data, the first historic data being previously provided to one or more downstream consumers and the first historic data being based on the first system of representation of information, (ii) issuing a second request for the first historic data from the synthetic data source to obtain the synthetic data, the synthetic data being based on the second system of representation of information, (iii) mapping portions of the synthetic data to corresponding portions of the first historic data to identify a second relationship between the first system of representation of information and the second system of representation of information, and/or (iv) obtaining the second translation schema based on the second relationship.

Obtaining the first historic data may include: (i) reading the first historic data from storage (e.g., by accessing a database of historic data, a data repository, etc.), (ii) requesting the first historic data from another entity responsible for managing a database of historic data and receiving the first historic data in response to the request, and/or (iii) other methods.

Issuing the second request for the first historic data from the synthetic data source to obtain the synthetic data may include: (i) using the first historic data to obtain an identifier associated with the first historic data (e.g., a timestamp, a characteristic, etc.), the identifier being usable to request the first historic data from the synthetic data source, (ii) transmitting a message to the synthetic data source, the message including a request for data associated with the identifier, (iii) obtaining a response to the first request in the form of a message, the response from the first request including the synthetic data. The synthetic data may include a synthetic updated instance of the first historic data.

Mapping the portions of the synthetic data to the corresponding portions of the first historic data to identify the second relationship may include: (i) obtaining a first set of elements from the first historic data, each element of the first set of the elements being associated with an identifier (e.g., a timestamp, etc. identifying a particular portion of the first historic data), (ii) obtaining a second set of elements from the synthetic updated instance of the first historic data, each element of the second set of the elements being associated with a corresponding element of the first historic data (e.g., via a matching associated identifier), and/or (iii) generating a series of connections, each connection of the series of the connections including an element from the first historic data and a corresponding element from the synthetic updated instance of the first historic data.

Mapping the portions of the synthetic data to corresponding portions of the first historic data may also include: (i) transmitting the synthetic updated instance of the first historic data and the first historic data to another entity responsible for generating the series of connections, and/or (ii) receiving the mapped portions (e.g., the series of connections) from the entity.

Obtaining the second translation schema based on the second relationship may include: (i) generating the second translation schema, (ii) providing the series of connections to another entity responsible for generating the second translation schema and receiving the second translation schema from the entity in response to the series of connections, (iii) reading the second translation schema from storage, and/or (iv) other methods.

At operation 304, it is determined whether the second translation schema has a second performance score that meets the performance score threshold. Determining whether the second translation schema has a second performance score that meets the performance score threshold may include: (i) obtaining the second performance score, and/or (ii) comparing the second performance score to the performance score threshold.

Obtaining the second performance score may include: (i) obtaining second historic data from a database of historic data. (ii) querying the synthetic data source to obtain a synthetic updated instance of the second historic data, (iii) utilizing the second translation schema to translate the synthetic updated instance of the second historic data to a translated synthetic instance of the second historic data, and/or (iv) generating the second performance score based on a degree to which the translated synthetic instance of the second historic data matches the second historic data (and/or other factors such as translation schema complexity).

Generating the second performance score may include: (i) obtaining a difference between the translated synthetic instance of the second historic data and the second historic data, (ii) comparing the difference to schema for determining performance scores based on differences, (iii) identifying elements (e.g., steps involved, computing resources required, etc.) of the second translation schema to determine the degree of complexity of the second translation schema. (iv) modifying the second performance score to indicate a more successful remediation of the change in the system of representation of information when the second translation schema includes fewer elements, and/or (v) other methods.

Obtaining the second performance score may also include: (i) transmitting second historic data, the synthetic updated instance of the second historic data, instructions for obtaining the second performance score, and/or any other data to another entity responsible for generating the second performance score, (ii) reading the second performance score from storage, and/or (iii) other methods.

Comparing the second performance score to the performance score threshold may include: (i) obtaining the performance score threshold, (ii) determining whether the second performance score meets the performance score threshold (e.g., by comparing a quantification of the second performance score to a quantification associated with the performance score threshold), (iii) transmitting the second performance score and the performance score threshold to another entity responsible for comparing the second performance score to the performance score threshold, (iv) inputting the second performance score and/or the performance score threshold into an inference model or rules-based engine trained to determine whether performance scores meet thresholds, and/or (v) other methods.

Obtaining the performance score threshold may include: (i) reading the performance score threshold from storage, (ii) querying an entity (e.g., a downstream consumer, etc.) to provide the performance score threshold, (iii) generating the performance score threshold based on information obtained regarding the preferences and/or characteristics of the one or more downstream consumers, and/or (iv) other methods.

If the second translation schema has a second performance score that meets the performance score threshold, the method may proceed to operation 306. If the second translation schema does not have a second performance score that meets the performance score threshold, the method may return to operation 302 and an additional (e.g., different from the second translation schema) may be obtained and tested using processes similar to those described above for obtaining and testing the second translation schema.

At operation 306, an action set to implement the second translation schema in the data pipeline is performed. Performing the action set may include: (i) obtaining a translation layer for the data pipeline, the translation layer being adapted to initiate implementation of the second translation schema when future instances of data based on the second system of representation of information are identified, (ii) updating the data pipeline using the translation layer, and/or (iii) providing instructions to the data pipeline, the instructions indicating conditions under which the translation layer is to be utilized (e.g., when data is obtained from certain data sources, etc.).

Obtaining the translation layer may include: (i) generating the translation layer, (ii) reading the translation layer from storage, (iii) receiving the translation layer from another entity responsible for generating translation layers, and/or (iv) other methods.

Performing the action set may also include: (i) generating and/or otherwise obtaining a notification of the actions performed in response to the change in the system of representation of information (e.g., the implementation of the translation layer), (ii) storing the notification in storage and/or providing the notification to another entity (e.g., the downstream consumer, administrators responsible for managing the data pipeline, etc.), and/or (iii) other actions to record the modifications made to the data pipeline.

The method may end following operation 306.

Turning to FIG. 3B, a flow diagram illustrating a method of identifying that a first translation schema has a first performance score that falls below a performance score threshold in accordance with an embodiment is shown. The method may be performed, for example, by a data source, data manager, downstream consumer, and/or any other entity. The operations shown in FIG. 3B may be an expansion of operation 300 in FIG. 3A.

At operation 310, data from one or more data sources associated with a data pipeline are obtained, the data being intended to be provided to one or more downstream consumers associated with the data pipeline. Obtaining the data may include: (i) reading the data from storage (e.g., from a data repository, data lake, and/or any other storage structure), (ii) collecting the data (e.g., via a sensor positioned in an ambient environment), (iii) obtaining the data from another entity responsible for collecting and/or storing the data, (iv) accessing a database using access credentials to obtain the data, and/or (v) other methods.

At operation 312, it is determined whether the data includes anomalous data. Determining whether the data includes anomalous data may include: (i) performing an anomaly detection process using the data, (ii) receiving a notification from another entity that the data includes anomalous data, (iii) locating the data in a database labeled as including anomalous data, and/or (iv) other methods.

Performing the anomaly detection process using the data may include: (i) obtaining a degree of anomalousness for the data, (ii) comparing the degree of anomalousness to an anomalousness threshold, (iii) performing a data drift monitoring process to determine whether the anomaly persists, and/or (iv) if the anomaly persists, identifying a data drift event that may be associated with the change in the system of representation of information.

Obtaining the degree of anomalousness for the data may include: (i) performing a cluster analysis using the data, (ii) performing an isolation forest process using unsupervised machine learning. (iii) performing a statistical analysis to compare each element of the data to historic data trends (e.g., via determining a number of standard deviations away from the historic data mean each element of the data is), and/or (iv) other methods.

Performing the data drift monitoring process may include: (i) screening incoming data for the identified anomaly for a previously determined period of time, (ii) recording instances of the identified anomaly in the incoming data, and/or (iii) determining whether the instances of the identified anomaly indicate a data drift using data drift criteria.

If the data includes the anomalous data (an identified anomaly with a subsequent data drift), the method may proceed to operation 314. If the data does not include the anomalous data, the method may end following operation 312.

At operation 314, a first translation schema intended to remediate a change in a system of representation of information indicated by the anomalous data is obtained. Obtaining the first translation schema may include: (i) obtaining first historic data, (ii) issuing a first request for the first historic data from the one or more data sources to obtain an updated instance of the first historic data. (iii) mapping portions of the updated instance of the first historic data to corresponding portions of the first historic data to identify a relationship between the first system of representation of information and the second system of representation of information, and/or (iv) obtaining the translation schema based on the relationship.

Obtaining the first historic data may include: (i) reading the first historic data from storage (e.g., by accessing a database of historic data, data repository, etc.), (ii) requesting the first historic data from another entity responsible for managing a database of historic data and receiving the first historic data in response to the request, and/or (iii) other methods.

Issuing the first request for the first historic data from the one or more data sources may include: (i) using the first historic data to obtain an identifier associated with the first historic data (e.g., a timestamp, a characteristic, etc.), the identifier being usable to request the first historic data from the one or more data sources, (ii) transmitting a message to the one or more data sources, the message including a request for data associated with the identifier, (iii) obtaining a response to the first request in the form of a message, the response from the first request including the updated instance of the first historic data.

Mapping the portions of the updated instance of the first historic data to corresponding portions of the first historic data may include: (i) obtaining a first set of elements from the first historic data, each element of the first set of the elements being associated with an identifier (e.g., a timestamp, etc. identifying a particular portion of the first historic data), (ii) obtaining a second set of elements from the updated instance of the first historic data, each element of the second set of the elements being associated with a corresponding element of the first historic data (e.g., via a matching associated identifier), and/or (iii) generating a series of connections, each connection of the series of the connections including an element from the first historic data and a corresponding element from the updated historic data.

Mapping the portions of the updated instance of the first historic data to corresponding portions of the first historic data may also include: (i) transmitting the updated instance of the first historic data and the first historic data to another entity responsible for generating the series of connections, and/or (ii) receiving the mapped portions (e.g., the series of connections) from the entity.

Obtaining the translation schema based on the relationship may include: (i) generating the translation schema, (ii) providing the series of connections to another entity responsible for generating the translation schema and receiving the translation schema from the entity in response to the series of connections, (iii) reading the translation schema from storage, and/or (iv) other methods.

At operation 316, a first performance score is obtained. Obtaining the first performance score may include: (i) obtaining second historic data from a database of historic data, (ii) querying the synthetic data source to obtain a synthetic updated instance of the second historic data, (iii) utilizing the second translation schema to translate the synthetic updated instance of the historic data to a translated synthetic instance of the second historic data, and/or (iv) generating the second performance score based on a degree to which the first translation schema successfully remediates the change in the system of representation of information (e.g., a degree to which the translated synthetic instance of the second historic data matches the second historic data) and/or other factors (e.g., a degree of complexity of the first translation schema).

Generating the first performance score may include: (i) obtaining a difference between the translated synthetic instance of the second historic data and the second historic data, (ii) comparing the difference to schema for determining performance scores based on differences, (iii) identifying elements (e.g., steps involved, computing resources required, etc.) of the first translation schema to determine the degree of complexity of the first translation schema, (iv) modifying the first performance score to indicate a more successful remediation of the change in the system of representation of information when the first translation schema includes fewer elements, and/or (v) other methods.

Obtaining the second performance score may also include: (i) transmitting second historic data, the synthetic updated instance of the second historic data, instructions for obtaining the second performance score, and/or any other data to another entity responsible for generating the second performance score, (ii) reading the second performance score from storage, and/or (iii) other methods.

At operation 318, the first performance score may be compared to a performance score threshold. Comparing the first performance score to the performance score threshold may include: (i) obtaining the performance score threshold, (ii) determining whether the first performance score meets the performance score threshold (e.g., by comparing a quantification of the first performance score to a quantification associated with the performance score threshold), (iii) transmitting the first performance score and the performance score threshold to another entity responsible for comparing the first performance score to the performance score threshold, (iv) inputting the first performance score and/or the performance score threshold into an inference model or rules-based engine trained to determine whether performance scores meet thresholds, and/or (v) other methods.

Obtaining the performance score threshold may include: (i) reading the performance score threshold from storage, (ii) querying an entity (e.g., a downstream consumer, etc.) to provide the performance score threshold, (iii) generating the performance score threshold based on information obtained regarding the preferences and/or characteristics of the one or more downstream consumers, and/or (iv) other methods.

The method may end following operation 318.

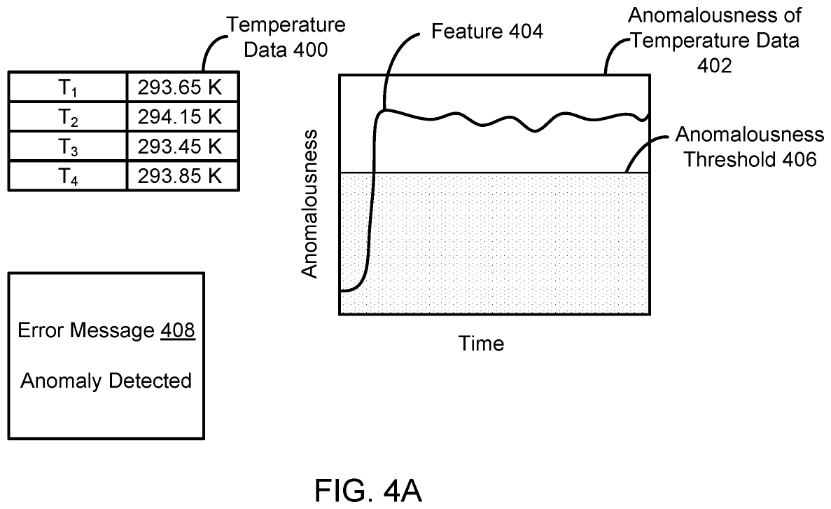

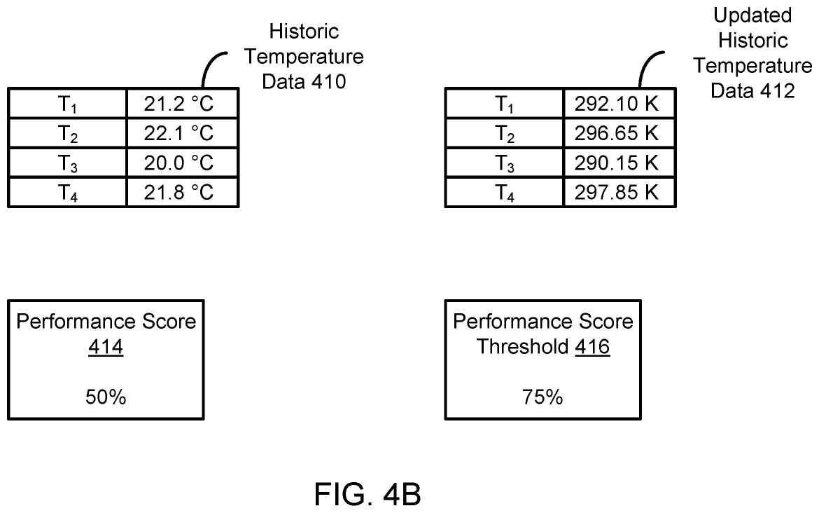

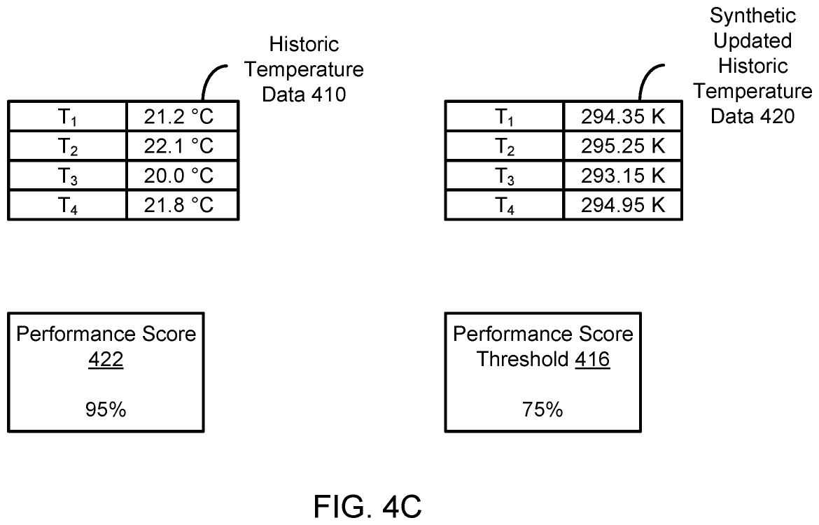

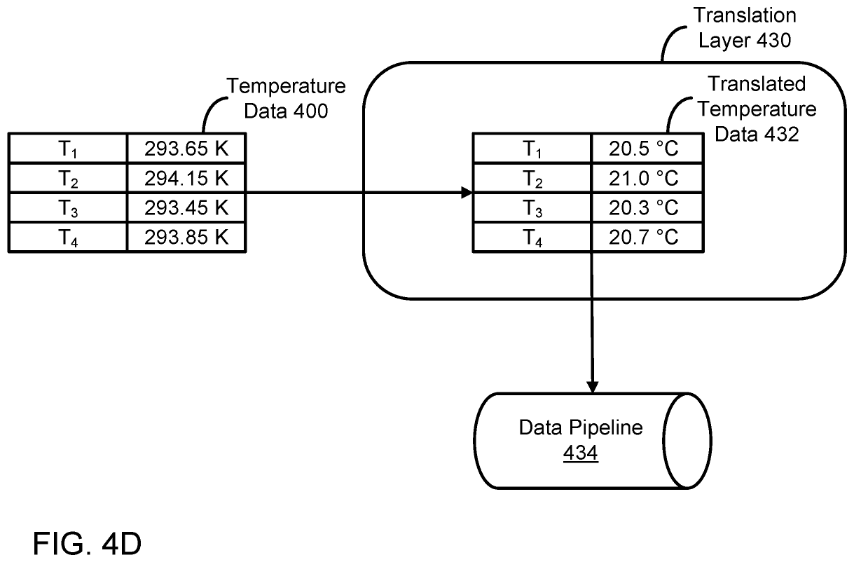

Turning to FIG. 4A, consider a scenario in which one or more downstream consumers associated with a data pipeline issued a request to an API for data usable to provide computer-implemented services. The requested data may include temperature data 400. Prior to providing temperature data 400 to the one or more downstream consumers, an anomaly detection process may be performed using at least temperature data 400 to obtain anomalousness of temperature data 402.

Anomalousness of temperature data 402 may include a graphical representation of degrees of anomalousness of portions of data over time. The portion of data that includes temperature data 400 may be associated with the feature 404. Feature 404 may indicate that the degree of anomalousness associated with temperature data 400 exceeds anomalousness threshold 406. Consequently, error message 408 may be generated, error message 408 indicating that an anomaly has been detected in temperature data 400. The anomaly in temperature data 400 may be treated as being caused by a change in a system of representation of information.

Turning to FIG. 4B, the anomaly associated with temperature data 400 may be remediated by generating a first translation schema (not shown). To generate the first translation schema, historic temperature data 410 may be obtained from a historic data database. Historic temperature data 410 may be based on a first system of representation of information (e.g., temperature measurements in degrees Celsius) and may not have been previously flagged as anomalous. To determine whether the change in the system of representation of information has occurred, a request for the temperature measurements associated with historic temperature data 410 may be transmitted to the data source that initially provided historic temperature data 410. Updated historic temperature data 412 may be obtained in response.

Updated historic temperature data 412 may be based on a second system of representation of information (temperature in Kelvin) and may be influenced by a stochastic element present in the data source. To obtain the first translation schema, each element of historic temperature data 410 (e.g., the temperature value at T₁, etc.) may be connected to a corresponding element of updated historic temperature data 412 (e.g., the temperature value at T₁, etc.). These connections may be used to determine how to translate the second system of representation of information to the first system of representation of information (e.g., converting degrees Celsius to Kelvin).

Following generation of the first translation schema, the first translation schema may be tested to determine a degree to which the first translation schema successfully translates between the first system of representation of information (e.g., temperature in degrees Celsius) and the second system of representation of information (temperature in Kelvin). The testing process may yield performance score 414 of 50%. In order for the first translation schema to be implemented in the data pipeline, it may be previously established that performance score 414 must at least meet performance score threshold 416 of 75%. Therefore, the first translation schema may not be implemented in the data pipeline. This may trigger generation and testing of a second transition schema using synthetic data from a synthetic data source as described below.

Turning to FIG. 4C, a second translation schema may be generated using historic temperature data 410 and synthetic updated historic temperature data 420. Synthetic updated historic temperature data 420 may be obtained using a digital twin of the data source (not shown), the digital twin being intended to duplicate operation of the data source. The digital twin may exclude the stochastic element and, therefore, synthetic updated historic temperature data 420 may not be influenced by the stochastic element.

The absence of the stochastic element makes it more likely that a reliable mapping may be generated between the first system of representation of information and the second system of representation of information. The second translation schema may subsequently be tested and performance score 422 of 95% may be obtained. Performance score 422 of 95% may meet performance score threshold 416 of 75% and, therefore, the second translation schema may be considered acceptable for implementation in the data pipeline.

Turning to FIG. 4D, translation layer 430 may be added to data pipeline 434. Translation layer 430 may implement the previously obtained second translation schema to translate temperature data 400 to translated temperature data 432. Translated temperature data 432 may be generated by translation layer 430 converting each element of temperature data 400 to degrees Celsius. Translated temperature data 432 may then be inputted into data pipeline 434 and provided to the downstream consumer.

Any of the components illustrated in FIGS. 1-4D may be implemented with one or more computing devices. Turning to FIG. 5, a block diagram illustrating an example of a data processing system (e.g., a computing device) in accordance with an embodiment is shown. For example, system 500 may represent any of data processing systems described above performing any of the processes or methods described above. System 500 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 500 is intended to show a high level view of many components of the computer system. However, it is to be understood that additional components may be present in certain implementations and furthermore, different arrangement of the components shown may occur in other implementations. System 500 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 500 includes processor 501, memory 503, and devices 505-507 via a bus or an interconnect 510. Processor 501 may represent a single processor or multiple processors with a single processor core or multiple processor cores included therein. Processor 501 may represent one or more general-purpose processors such as a microprocessor, a central processing unit (CPU), or the like. More particularly, processor 501 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 501 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 501, which may be a low power multi-core processor socket such as an ultra-low voltage processor, may act as a main processing unit and central hub for communication with the various components of the system. Such processor can be implemented as a system on chip (SoC). Processor 501 is configured to execute instructions for performing the operations discussed herein. System 500 may further include a graphics interface that communicates with optional graphics subsystem 504, which may include a display controller, a graphics processor, and/or a display device.

Processor 501 may communicate with memory 503, which in one embodiment can be implemented via multiple memory devices to provide for a given amount of system memory. Memory 503 may include one or more volatile storage (or memory) devices such as random access memory (RAM), dynamic RAM (DRAM), synchronous DRAM (SDRAM), static RAM (SRAM), or other types of storage devices. Memory 503 may store information including sequences of instructions that are executed by processor 501, or any other device. For example, executable code and/or data of a variety of operating systems, device drivers, firmware (e.g., input output basic system or BIOS), and/or applications can be loaded in memory 503 and executed by processor 501. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 500 may further include IO devices such as devices (e.g., 505, 506, 507, 508) including network interface device(s) 505, optional input device(s) 506, and other optional IO device(s) 507. Network interface device(s) 505 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 506 may include a mouse, a touch pad, a touch sensitive screen (which may be integrated with a display device of optional graphics subsystem 504), a pointer device such as a stylus, and/or a keyboard (e.g., physical keyboard or a virtual keyboard displayed as part of a touch sensitive screen). For example, input device(s) 506 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 507 may include an audio device. An audio device may include a speaker and/or a microphone to facilitate voice-enabled functions, such as voice recognition, voice replication, digital recording, and/or telephony functions. Other IO devices 507 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 507 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 510 via a sensor hub (not shown), while other devices such as a keyboard or thermal sensor may be controlled by an embedded controller (not shown), dependent upon the specific configuration or design of system 500.

To provide for persistent storage of information such as data, applications, one or more operating systems and so forth, a mass storage (not shown) may also couple to processor 501. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 501, e.g., via a serial peripheral interface (SPI). This flash device may provide for non-volatile storage of system software, including a basic input/output software (BIOS) as well as other firmware of the system.

Storage device 508 may include computer-readable storage medium 509 (also known as a machine-readable storage medium or a computer-readable medium) on which is stored one or more sets of instructions or software (e.g., processing module, unit, and/or processing module/unit/logic 528) embodying any one or more of the methodologies or functions described herein. Processing module/unit/logic 528 may represent any of the components described above. Processing module/unit/logic 528 may also reside, completely or at least partially, within memory 503 and/or within processor 501 during execution thereof by system 500, memory 503 and processor 501 also constituting machine-accessible storage media. Processing module/unit/logic 528 may further be transmitted or received over a network via network interface device(s) 505.

Computer-readable storage medium 509 may also be used to store some software functionalities described above persistently. While computer-readable storage medium 509 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 528, components and other features described herein can be implemented as discrete hardware components or integrated in the functionality of hardware components such as ASICS, FPGAs, DSPs or similar devices. In addition, processing module/unit/logic 528 can be implemented as firmware or functional circuitry within hardware devices. Further, processing module/unit/logic 528 can be implemented in any combination hardware devices and software components.

Note that while system 500 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method of managing a data pipeline, the method comprising:
making a first identification that a first translation schema has a first performance score that falls below a performance score threshold, the first translation schema being intended to remediate a change in a system of representation of information conveyed by data obtained from a data source and the data source comprising a stochastic element that influences the data;
obtaining, in response to the first identification, a second translation schema based, at least in part, on synthetic data from a synthetic data source, the synthetic data source being intended to generalize operation of the data source and the synthetic data source excluding the stochastic element so that the synthetic data is not influenced by the stochastic element;
making a first determination regarding whether the second translation schema has a second performance score that meets the performance score threshold; and
in an instance of the first determination in which the second translation schema has the second performance score that meets the performance score threshold:
performing an action set to implement the second translation schema in the data pipeline.

2. The method of claim 1, further comprising:
prior to making the first identification:
making a second determination regarding whether the data comprises anomalous data, the anomalous data indicating the change in the system of representation of information; and
in an instance of the second determination in which the data comprises the anomalous data:
obtaining the first translation schema.

3. The method of claim 2, wherein obtaining the first translation schema comprises:
obtaining first historic data, the first historic data being previously provided to one or more downstream consumers and the first historic data being based on a first system of representation of information;
issuing a first request for the first historic data from the data source to obtain an updated instance of the first historic data, the updated instance of the first historic data being based on a second system of representation of information;
mapping portions of the updated instance of the first historic data to corresponding portions of the first historic data to identify a first relationship between the first system of representation of information and the second system of representation of information; and
obtaining the first translation schema based on the first relationship.

4. The method of claim 3, wherein making the first identification comprises:
obtaining the first performance score, the first performance score indicating a degree to which the first translation schema successfully remediates the change in the system of representation of information; and
comparing the first performance score to the performance score threshold.

5. The method of claim 4, wherein an influence of the stochastic element on the data negatively impacts the first performance score.

6. The method of claim 4, wherein obtaining the second translation schema comprises:
obtaining the first historic data;
issuing a second request for the first historic data from the synthetic data source to obtain the synthetic data, the synthetic data being based on the second system of representation of information;
mapping portions of the synthetic data to corresponding portions of the first historic data to identify a second relationship between the first system of representation of information and the second system of representation of information; and
obtaining the second translation schema based on the second relationship.

7. The method of claim 6, wherein the synthetic data source comprises one selected from a list consisting of:
a digital twin of the data source; and
an inference model trained to generalize the operation of the data source.

8. The method of claim 7, wherein making the first determination comprises:
obtaining the second performance score, the second performance score indicating a degree to which the second translation schema successfully remediates the change in the system of representation of information; and
comparing the second performance score to the performance score threshold.

9. The method of claim 8, wherein performing the action set comprises:
obtaining a translation layer for the data pipeline, the translation layer being adapted to initiate implementation of the second translation schema when future instances of data based on the second system of representation of information are identified.

10. A non-transitory machine-readable medium having instructions stored therein, which when executed by a processor, cause the processor to perform operations for managing a data pipeline, the operations comprising:
making a first identification that a first translation schema has a first performance score that falls below a performance score threshold, the first translation schema being intended to remediate a change in a system of representation of information conveyed by data obtained from a data source and the data source comprising a stochastic element that influences the data;
obtaining, in response to the first identification, a second translation schema based, at least in part, on synthetic data from a synthetic data source, the synthetic data source being intended to generalize operation of the data source and the synthetic data source excluding the stochastic element so that the synthetic data is not influenced by the stochastic element;
making a first determination regarding whether the second translation schema has a second performance score that meets the performance score threshold; and
in an instance of the first determination in which the second translation schema has the second performance score that meets the performance score threshold:
performing an action set to implement the second translation schema in the data pipeline.

11. The non-transitory machine-readable medium of claim 10, further comprising:
prior to making the first identification:
making a second determination regarding whether the data comprises anomalous data, the anomalous data indicating the change in the system of representation of information; and
in an instance of the second determination in which the data comprises the anomalous data:
obtaining the first translation schema.

12. The non-transitory machine-readable medium of claim 11, wherein obtaining the first translation schema comprises:
obtaining first historic data, the first historic data being previously provided to one or more downstream consumers and the first historic data being based on a first system of representation of information;
issuing a first request for the first historic data from the data source to obtain an updated instance of the first historic data, the updated instance of the first historic data being based on a second system of representation of information;
mapping portions of the updated instance of the first historic data to corresponding portions of the first historic data to identify a first relationship between the first system of representation of information and the second system of representation of information; and
obtaining the first translation schema based on the first relationship.

13. The non-transitory machine-readable medium of claim 12, wherein making the first identification comprises:
obtaining the first performance score, the first performance score indicating a degree to which the first translation schema successfully remediates the change in the system of representation of information; and
comparing the first performance score to the performance score threshold.

14. The non-transitory machine-readable medium of claim 13, wherein an influence of the stochastic element on the data negatively impacts the first performance score.

15. The non-transitory machine-readable medium of claim 13, wherein obtaining the second translation schema comprises:
obtaining the first historic data;
issuing a second request for the first historic data from the synthetic data source to obtain the synthetic data, the synthetic data being based on the second system of representation of information;
mapping portions of the synthetic data to corresponding portions of the first historic data to identify a second relationship between the first system of representation of information and the second system of representation of information; and
obtaining the second translation schema based on the second relationship.

16. A data processing system, comprising:
a processor; and
a memory coupled to the processor to store instructions, which when executed by the processor, cause the processor to perform operations for managing a data pipeline, the operations comprising:
making a first identification that a first translation schema has a first performance score that falls below a performance score threshold, the first translation schema being intended to remediate a change in a system of representation of information conveyed by data obtained from a data source and the data source comprising a stochastic element that influences the data;
obtaining, in response to the first identification, a second translation schema based, at least in part, on synthetic data from a synthetic data source, the synthetic data source being intended to generalize operation of the data source and the synthetic data source excluding the stochastic element so that the synthetic data is not influenced by the stochastic element;
making a first determination regarding whether the second translation schema has a second performance score that meets the performance score threshold; and
in an instance of the first determination in which the second translation schema has the second performance score that meets the performance score threshold:
performing an action set to implement the second translation schema in the data pipeline.

17. The data processing system of claim 16, further comprising:
prior to making the first identification:
making a second determination regarding whether the data comprises anomalous data, the anomalous data indicating the change in the system of representation of information; and
in an instance of the second determination in which the data comprises the anomalous data:
obtaining the first translation schema.

18. The data processing system of claim 17, wherein obtaining the first translation schema comprises:
obtaining first historic data, the first historic data being previously provided to one or more downstream consumers and the first historic data being based on a first system of representation of information;
issuing a first request for the first historic data from the data source to obtain an updated instance of the first historic data, the updated instance of the first historic data being based on a second system of representation of information;
mapping portions of the updated instance of the first historic data to corresponding portions of the first historic data to identify a first relationship between the first system of representation of information and the second system of representation of information; and
obtaining the first translation schema based on the first relationship.

19. The data processing system of claim 16, wherein making the first identification comprises:
obtaining the first performance score, the first performance score indicating a degree to which the first translation schema successfully remediates the change in the system of representation of information; and
comparing the first performance score to the performance score threshold.

20. The data processing system of claim 19, wherein an influence of the stochastic element on the data negatively impacts the first performance score.
